(19) United States
(12) Patent Application Publication
(10) Pub. No.: US 2012/0243725 A1
(43) Pub. Date: Sep. 27, 2012

(54) EARPHONE

(75) Inventors: Kanemori Takai, Shinagawa (JP); Atsuhito Horino, Ebina (JP); Tomonari Kaneko, Ebina (JP); Masahiro Yamaguchi, Shinagawa (JP)

(73) Assignees: S'NEXT Company, Ltd., Shinagawa-ku, TOKYO (JP); Molex Incorporated, Lisle, IL (US)

(21) Appl. No.: 13/392,737

(22) PCT Filed: Aug. 25, 2010
(86) PCT No.: PCT/US10/46681

§ 371 Date: Jun. 13, 2012

(30) Foreign Application Priority Data
Aug. 25, 2009 (JP) 2009-194328
Aug. 25, 2009 (JP) 2009-194633
Aug. 25, 2009 (JP) 2009-194644

(51) Int. Cl. H04R 1/10

(52) U.S. Cl. 381/380

(57) ABSTRACT

An earphone is disclosed. The earphone comprises an external auditory meatus insertion member, a casing and a driver unit. At least a part of the external auditory meatus insertion member is insertable into an external auditory meatus. The external auditory meatus insertion member is attached to the casing. The driver unit is disposed within the casing to generate sounds. The casing includes a front space formed in front of the driver unit, a sound guide hole in communication with the front end of the front space to cause sounds to impinge on the external auditory meatus, and a rear space formed in the rear of the driver unit.

### REFERENCE TO RELATED APPLICATIONS

The Present Application claims priority to prior-filed Japanese Patent Application Nos. 2009-194328, entitled “Ear Pad And Earphone Having The Same;” 2009-194633, entitled “Earphone;” and 2009-194644, entitled “Earphone.” Each of these aforementioned Applications was filed with the Japanese Patent Office on 25 Aug. 2009. Further, the contents of each of these aforementioned Applications are fully incorporated herein in their entireties.

### BACKGROUND OF THE PRESENT APPLICATION

The Present Application relates to an earphone having an external auditory meatus insertion member at least a part of which is inserted into an external auditory meatus.

Conventionally, as an earphone attached to an auricle when it is used, there has been known an earphone, which does not have a projection portion to be inserted into the external auditory meatus, that is, so-called an earphone-type headphone. An example of this type of earphone is disclosed in Japanese Utility Model Application No. H4-050718. This type of earphone has, for example, a dynamic-type driver unit and generates sounds by vibrating a diaphragm in the driver unit.

FIG. 8 is a cross section illustrating the structure of a conventional earphone. Referring to FIG. 8, a rear housing 813 of the earphone is equipped with a driver unit 841 in the inside of the rear housing 813. Further, a ring-shaped front housing 812 fit in the tip (the lower end in FIG. 8) of the rear housing 813 fixes the driver unit 841. Moreover, a duct-shaped cable holding portion 815 extends from the rear surface of the rear housing 813 and houses an electric wire cable 891 one end of which is connected to the driver unit 841 and the other end of which is connected to audio equipment, which is not shown, such as a music player, a television, a radio, or a video recorder, which is not shown.

Further, the driver unit 841 includes a magnet 843, a plate 844, and a yoke 845, which form a magnetic circuit, and a diaphragm 846 and a voice coil 847, which form a vibration system. Specifically, the plate 844 and the yoke 845 are secured to both sides of the disk-shaped magnet 843. The magnet 843 is, for example, a samarium cobalt magnet. Moreover, a magnetic gap is formed in a space to which the plate 844 and the yoke 845 are opposed and the voice coil 847 secured to the diaphragm 846 is inserted into the magnetic gap. The diaphragm 846 is, for example, a polyester film. A meshed protection plate 848, having a lot of relatively large openings, is disposed in the front of the earphone, namely in front (the lower side in FIG. 8) of the diaphragm 846.

A through-hole 849 is formed in the center of the magnet 843, the plate 844, and the yoke 845, and a resistor material 871 made of urethane foam or the like is buried in the through-hole 849. Further, a plurality of holes 870 are formed in the driver unit 841.

When the earphone is attached into the concave portion of the auricle, a protection plate 848 disposed in the front of the earphone is opposed to the entrance of the external auditory meatus, and sounds generated by the vibration of the diaphragm 846 impinge on the inside of the external auditory meatus through the openings of the protection plate 848 and reach the eardrum.

Nevertheless, in the conventional earphone, the earphone is attached to the concave portion of the auricle, which leads to poor wearability. Particularly in cases where a user is not in a resting state such as during walking, the earphone sometimes falls off the auricle. Moreover, the poor wearability destabilizes the positional relationship with the external auditory meatus and thus destabilizes the sound volume and sound quality of the sounds impinging on the external auditory meatus. Accordingly, in recent years, there has been provided an earphone having an ear pad made of soft rubber or the like having elasticity so that the ear pad is inserted into the external auditory meatus. This type of earphone is attached by inserting the flexible ear pad into the external auditory meatus and therefore is able to be reliably attached to the auricle and does not fall off the auricle during walking. Moreover, the ear pad is made of material having elasticity and therefore is easily elastically deformable according to the shape of the external auditory meatus, thereby providing good wearing feeling.

When the ear pad is inserted into the external auditory meatus, however, the ear pad pressed and deformed by the external auditory meatus blocks the communication between the inside and the outside of the external auditory meatus, thereby inhibiting the sounds, which impinged on the external auditory meatus from the earphone, from being let out to the outside. This deteriorates so-called sound clearness and generates muffled or unclear sounds or the like, thus reducing the sound quality. Moreover, resonance of the ear pad sometimes occurs in a low frequency band.

### SUMMARY OF THE PRESENT APPLICATION

Therefore, the Present Application has been made to solve the foregoing conventional problems and has an object to provide an earphone capable of reproducing sharp low sounds and clear mid and high sounds, while favorably letting out the sounds, and providing a good wearing feeling and high sound quality by forming an air control hole in each of sound spaces respectively formed in front and the rear of the driver unit in a casing and forming a tone control hole having a smaller diameter than the air control hole in the sound space formed in the rear of the driver unit.

In order to achieve the above object, the Present Application provides an earphone comprising: an external auditory meatus insertion member at least a part of which is insertable into an external auditory meatus; a casing to which the external auditory meatus insertion member is attached; and a driver unit which is disposed within the casing to generate sounds, wherein: the casing includes a front space formed in front of the driver unit, a sound guide hole which is in communication with the front end of the front space to cause sounds to impinge on the external auditory meatus, and a rear space which is formed in the rear of the driver unit; the front space includes a front air control hole, which is in communication with the outside; and the rear space includes a rear air control hole which is in communication with the outside and a tone control hole, which is in communication with the outside, having a smaller diameter than the rear air control hole.

In another earphone according to the Present Application, further the rear air control hole and the tone control hole are disposed in a surface perpendicular to the vibrating direction of a diaphragm of the driver unit.

In still another earphone according to the Present Application, further the front space is a truncated cone-like space; the front air control hole is formed in a surface opposed to the driver unit in the front space so as to face forward; the rear space is a cylindrical space having a flat surface opposed to the driver unit; and the rear air control hole and the tone control hole are formed in a cylindrical side surface in the rear space so as to face laterally.

In still another earphone according to the Present Application, further the diameter of the front air control hole is equal to the diameter of the rear air control hole.

In still another earphone according to the Present Application, further the tone control hole includes a first control hole which controls the sound quality of a predetermined range and a second control hole which is smaller in diameter than the first control hole and controls the sound quality of lower sounds than the predetermined range.

According to the Present Application, an earphone has an air control hole in each of sound spaces respectively formed in front and the rear of a driver unit in a casing and a tone control hole having a smaller diameter than the air control hole in the sound space formed in the rear of the driver unit. Thereby, it is possible to reproduce sharp low sounds and clear mid and high sounds, while favorably letting out the sounds, and to provide a better wearing feeling and an improved sound quality.

### BRIEF DESCRIPTION OF THE FIGURES

The organization and manner of the structure and operation of the Present Application, together with further objects and advantages thereof, may best be understood by reference to the following Detailed Description, taken in connection with the accompanying Figures, wherein like reference numerals identify like elements, and in which:

FIG. 1 is a perspective view and also a partial cutaway view of an earphone according to the Present Application;

FIG. 2 is a five-side view of the earphone of FIG. 1, wherein FIG. 2A is from the top;

FIG. 2B, the left side; FIG. 2C, the rear; FIG. 2D, the right side; and FIG. 2E, the front;

FIG. 3 is a cross-section of the earphone of FIG. 1, taken along Line A-A of FIG. 2C;

FIG. 4 is a four-side view of an ear pad according to the Present Application, wherein FIG. 4A is from the left side; FIG. 4B, the rear; FIG. 4C, the right side; and FIG. 4D, the front;

FIG. 5 is a cross-section of the ear pad of FIG. 4, wherein FIG. 5A is a cross-section taken along Line B-B of FIG. 4B; FIG. 5B is a cross-section taken along Line C-C of FIG. 4B; FIG. 5C is a cross-section taken along Line D-D of FIG. 4C; and FIG. 5D is a cross-section taken along Line E-E of FIG. 4C;

FIG. 6 is a cross-section of an earphone according to the Present Application, taken along Line F-F of FIG. 7C;

FIG. 7 is a five-side view of the earphone of FIG. 6, wherein FIG. 7A is from the top;

FIG. 7B, the left side; FIG. 7C, the rear; FIG. 7D, the right side; and FIG. 7E, the front; and

FIG. 8 is a cross-section of a conventional earphone.

### DESCRIPTION OF THE PREFERRED EMBODIMENTS

While the Present Application may be susceptible to embodiment in different forms, there is shown in the Figures, and will be described herein in detail, specific embodiments, with the understanding that the disclosure is to be considered an exemplification of the principles of the Present Application, and is not intended to limit the Present Application to that as illustrated.

In the illustrated embodiments, directional representations—i.e., up, down, left, right, front, rear and the like, used for explaining the structure and movement of the various elements of the Present Application, are relative. These representations are appropriate when the elements are in the position shown in the Figures. If the description of the position of the elements changes, however, it is assumed that these representations are to be changed accordingly.

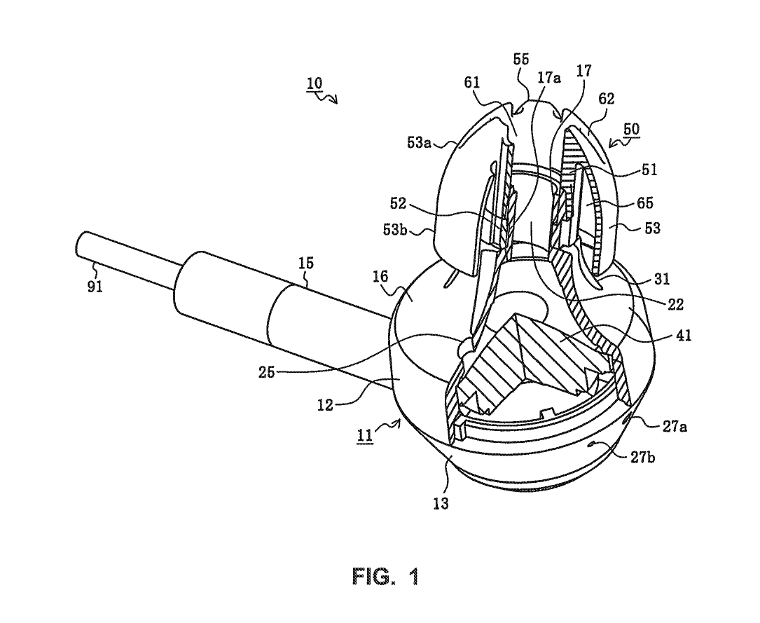

Referring to FIGS. 1-3, an earphone 10 is preferably attached to the auricle of a user when used and is a compact audio generator, which is driven by an audio signal as an electrical signal and reproduces the audio signal. Further, the earphone 10 has a casing 11 as a housing, which incorporates a driver unit 41 as a speaker unit for generating sounds by reproducing audio signals, and an ear pad 50 as a external auditory meatus insertion member, which is mounted on the casing 11 and is able to be inserted at least in its tip portion 55 into the external auditory meatus of the user.

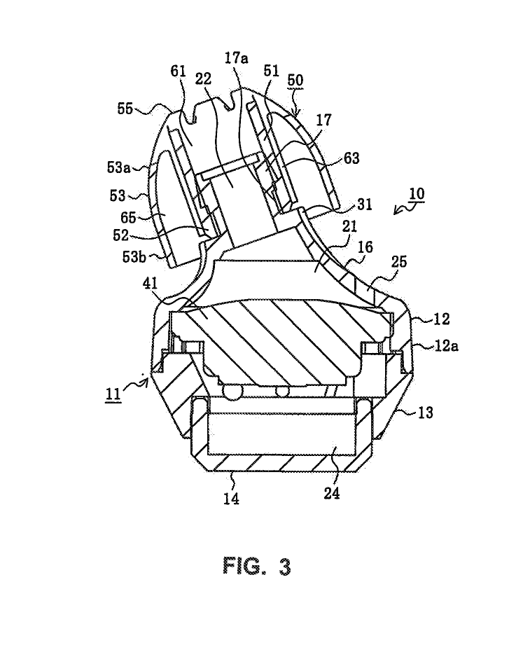

The casing 11 includes a front casing 12 located on the front side thereof, a truncated cone-like rear casing 13 connected to the rear side of a base 12a of the front casing 12, and a lid casing 14 connected to the rear side of the rear casing 13. Further, as shown in FIG. 3, the driver unit 41 is held inside the casing 11 with its front and rear (the upper side and the lower side in FIG. 3) interposed between the front casing 12 and the rear casing 13. The driver unit 41 is of a so-called dynamic type and has the same structure as the driver unit 841 of the conventional earphone described in the paragraphs of “Description of the Related Art.” Specifically, the description of the driver unit 841 of the conventional earphone is invoked as the description of the driver unit 41.

Moreover, the rear surface of the rear casing 13 is closed by the lid casing 14, thereby forming a rear space 24, which is a space having the shape of a combination of a truncated cone and a cylinder, in the rear (the lower side in FIG. 3) of the driver unit 41 in the casing 11. The surface opposed to the driver unit 41 in the rear space 24 is an inner surface of the lid casing 14 and is a flat surface parallel to a diaphragm, which is not shown, of the driver unit 41.

Although the lid casing 14 is a member separated from the rear casing 13 in the shown example, the lid casing 14 may be formed integrally with the rear casing 13. Further, although the casing 11 is made of, for example, resin such as synthetic resin, the casing 11 may be made of either a metal such as aluminum, steel, copper and the like or a composite material made up of resin, carbon, metal and the like.

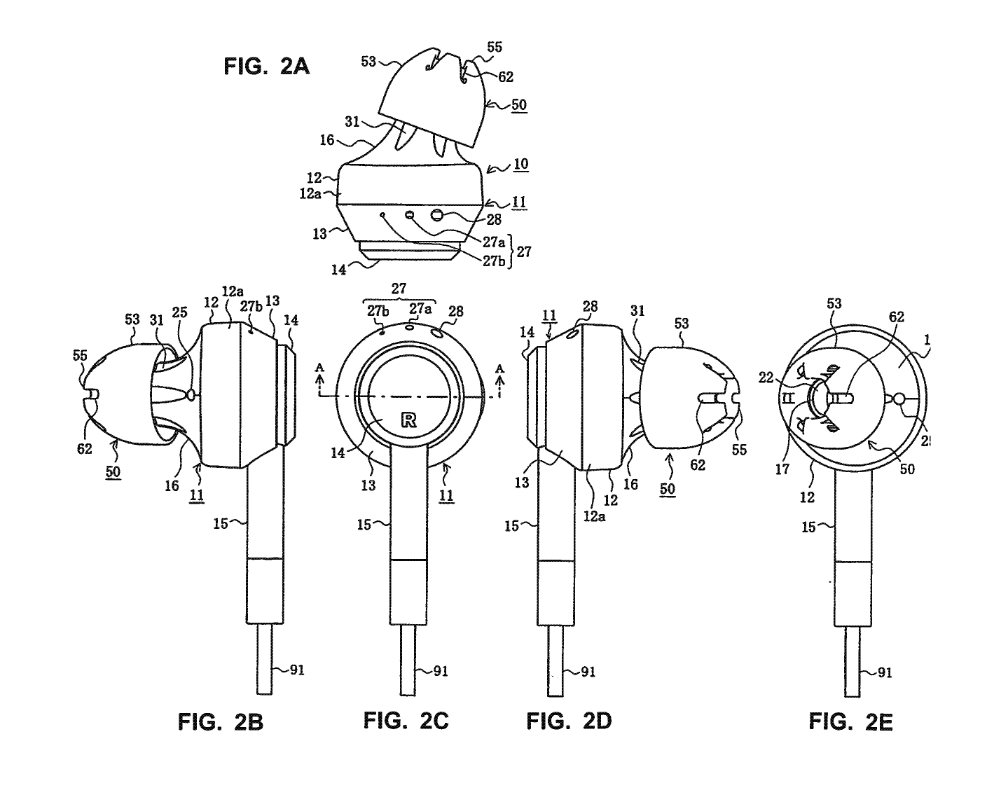

Further, the lid casing 14 is provided with an upper end, attached thereto, of a cylindrical cable holding portion 15 which encloses and holds a part of an electric wire cable 91, one end of which is connected to the driver unit 41. The cable holding portion 15 may be formed integrally with the lid casing 14. Further, the electric wire cable 91 extends from the lower end of the cable holding portion 15. In FIGS. 1 and 2, a picture of the electric wire cable 91 is drawn only in a part adjacent to the cable holding portion 15 and other parts are omitted for convenience of illustration. The other end, which is not shown, of the electric wire cable 91 is connected to audio equipment, which is not shown, such as a music player, a television, a radio, or a video recorder.

The front casing 12 includes a truncated cone-like conical portion 16, which projects forward from the base 12a, and a pad mounting portion 17 as a cylindrical insertion member mounting portion, which projects from the tip of the conical portion 16, in addition to the cylindrical base 12a. The conical portion 16 has a tip whose diameter is smaller than its base end (a portion connected to the base 12a), thereby forming a front space 21, which is a truncated cone-like space, in front of (the upper side in FIG. 3) the driver unit 41 in the casing 11. Further, in the pad mounting portion 17, there is formed a casing sound guide hole 22 as a sound guide hole which is a cylindrical opening whose rear end is in communication with the front space 21 and whose front end is open. Thereby, sounds generated by the driver unit 41 impinge on the external auditory meatus of a user through the front space 21 and the casing sound guide hole 22. Although the conical portion 16 is formed in such a way that the central axis of its tip is inclined rightward with respect to the central axis of the base end in the shown example, the central axis of the tip may be inclined in any direction with respect to the central axis of the base end. Further, the central axis of the tip does not always need to be inclined and may be parallel to the central axis of the base end.

Moreover, a front air duct 25 as a front air control hole, which is an air control hole functioning as an air vent, is formed in the conical portion 16 of the front casing 12. The front air duct 25 is a hole having a circular cross section, which is formed so as to pass through the conical portion 16, and communicating the front space 21 with the outside to enable the air in the front space 21 to be vented to the outside. The front air duct 25 is formed in a portion near the base 12a in the conical portion 16, that is, a surface portion which faces forward. In other words, the front air duct 25 is formed so as to face forward to enable the air in the front space 21 to be vented forward. Although the diameter of the front air duct 25 is, for example, 1.2 [mm], the diameter may be changed according to the performance of the driver unit 41, the size of the front space 21, or the like.

Moreover, a rear air duct 28 as a rear air control hole, which is an air control hole functioning as an air vent, and a first control hole 27a and a second control hole 27b as tone control holes are formed in the rear casing 13. In cases where the first control hole 27a and the second control hole 27b are collectively described, these holes are referred to as the control hole 27.

The rear air duct 28 is a hole having a circular cross section, which is formed so as to pass through the rear casing 13, and communicating the rear space 24 with the outside to enable the air in the rear space 24 to be vented to the outside. The rear air duct 28 is formed in a surface portion which faces laterally in the rear casing 13. In other words, the rear air duct 28 is formed so as to face laterally to enable the air in the rear space 24 to be vented laterally. Although the diameter of the rear air duct 28 is preset so as to be equal to the front air duct 25, the diameter may be changed according to the performance of the driver unit 41, the size of the rear space 24, or the like. As described above, the air vents having the same diameter, namely the front air duct 25 and the rear air duct 28 are disposed in the front space 21 and the rear space 24, respectively. Thereby, it is possible to correct sound distortion and echo and to improve the acoustic performance of the front space 21 and the rear space 24 as sound spaces. Further, the front air duct 25 and the rear air duct 28 are disposed, thereby enabling a reduction in a load on the diaphragm of the driver unit 41.

Moreover, the first control hole 27a and the second control hole 27b are holes each having a circular cross section formed so as to pass through the rear casing 13 and so as to face laterally, and communicating the rear space 24 with the outside. In addition, the first control hole 27a and the second control hole 27b are adjacent to the rear air duct 28 and disposed in line on the same circumference in the rear casing 13. Further, these holes are formed so that the diameter of the first control hole 27a is smaller than the diameter of the rear air duct 28 and the diameter of the second control hole 27b is smaller than the first control hole 27a.

The diameter of the first control hole 27a is, for example, 0.8 [mm]. With the setting of the diameter of the first control hole 27a to this value, it is possible to control the sounds in a frequency band of the mid-frequency sounds, that is, around 1200 [Hz], to provide smoother frequency responses, and to improve the sound quality. Further, the diameter of the second control hole 27b is, for example, 0.4 [mm]. With the setting of the diameter of the second control hole 27b to this value, it is possible to control the sounds in a frequency band of the low-frequency sounds, that is, around 200 [Hz], to provide smoother frequency responses, and to improve the sound quality.

Although there are provided the two tone control holes 27, the first control hole 27a and the second control hole 27b, in the shown example, the number of tone control holes 27 may be either one or more than three according to the frequency band to control. Moreover, the diameter of the tone control hole 27 may be changed according to the frequency band of the sounds to be controlled. More specifically, to control the sounds in a comparatively low frequency band, the diameter of the tone control hole 27 is decreased. To control the sounds in a comparatively high frequency band, the diameter of the tone control hole 27 is increased.

Further, the ear pad 50 is mounted on the pad mounting portion 17. The ear pad 50 is made of a soft elastically deformable material such as, for example, silicon rubber and is an integrally formed member, having a cylindrical body portion 51 fit around the pad mounting portion 17 and a cap portion 53 as an elastically deformable portion slantingly spreading from the tip of the body portion 51 toward the rear end thereof. At the rear end of the body portion 51, there is formed a thick flange-like engaging convex portion 52 projecting inward. The engaging convex portion 52 engages with a grooved engaging concave portion 17a, which is formed in the base end portion of the pad mounting portion 17 (a connecting portion to the tip of the conical portion 16), to prevent the ear pad 50 from being detached from the pad mounting portion 17.

The ear pad 50 has a mushroom- or umbrella-like shape as a whole. At a tip portion 55 of the ear pad 50, the tip of the body portion 51 is connected to the tip of the cap portion 53 and a cavity portion 65 is formed between the outer peripheral surface of the body portion 51 and the inner peripheral surface of the cap portion 53. Further, a pad sound guide hole 61 as a sound guide hole, which is a cylindrical opening with its front and rear ends open, is formed in the center of the body portion 51. The pad sound guide hole 61 is in communication with the casing sound guide hole 22 with the ear pad 50 mounted on the pad mounting portion 17.

Moreover, the cap portion 53 includes a truncated cone-like front half portion 53a, which spreads rearward, and a cylindrical rear half portion 53b, which extends in the rear direction from the rear end of the front half portion 53a. The cap portion 53 is thinner than the body portion 51 and is flexible. Therefore, the cap portion 53 is elastically deformed easily by receiving a force. Accordingly, when the ear pad 50 is inserted into the external auditory meatus, the cap portion 53 is elastically deformed so as to fit the inner surface shape of the external auditory meatus without damaging the external auditory meatus, and the cap portion 53 comes in close contact with the inner surface of the external auditory meatus without applying a reaction force to the inner surface, thereby providing good wearing and fit feelings, and the like.

Further, a plurality of (six in the shown example) radially extending slit-shaped openings 62 are formed in the front half portion 53a of the cap portion 53 when viewed from the tip side. When the user wears the earphone 10, the ear pad 50 is inserted into the external auditory meatus and the cap portion 53 blocks the communication between the inside and the outside of the external auditory meatus. The inside of the external auditory meatus, however, is in communication with the outside thereof due to the presence of the openings 62. Therefore, even in the state where the user wears the earphone 10, external environmental sounds such as an alarm impinge on the inside of the external auditory meatus and reach the eardrum, so that the safety is not reduced. Moreover, the air in the external auditory meatus is vented to the outside through the openings 62, thereby reducing the sense of pressure, muffled quality, and the like of the sounds which impinged on the inside of the external auditory meatus passing through the casing sound guide hole 22 and the pad sound guide hole 61 from the driver unit 41. This improves the sharpness of low sounds and provides clear mid and high sounds. Further, the sounds from the driver unit 41 do not press the eardrum and therefore the earphone 10 is also favorable to the health.

In the outer peripheral surface of the body portion 51, there are formed pad grooves 63 as grooves each extending in the fore-and-aft direction, namely in the axial direction of the body portion 51 in the places corresponding to the openings 62, respectively. Therefore, even in cases where the cap portion 53 is deformed and pressed against the outer peripheral surface of the body portion 51 when the ear pad 50 is inserted into the external auditory meatus, the openings 62 overlap with the pad grooves 63 corresponding thereto, thereby maintaining the communication between the inside and the outside of the external auditory meatus.

Further, at least in the vicinity of the connecting portion of the pad mounting portion 17 on the surface of the conical portion 16 of the front casing 12, there are formed casing grooves 31 as grooves extending in the fore-and-aft direction, namely in the axial direction of the conical portion 16 in the places corresponding to the pad grooves 63, respectively. Moreover, the tips of the casing grooves 31 are in communication with the rear ends of the pad grooves 63, respectively, and extend more rearward than the rear end of the cap portion 53. Therefore, even in cases where the cap portion 53 is deformed and pressed against not only the outer peripheral surface of the body portion 51, but the surface of the conical portion 16 when the ear pad 50 is inserted into the external auditory meatus, the openings 62 are in communication with the pad grooves 63 and the casing grooves 31 corresponding to the openings 62, thereby maintaining the communication between the inside and the outside of the external auditory meatus.

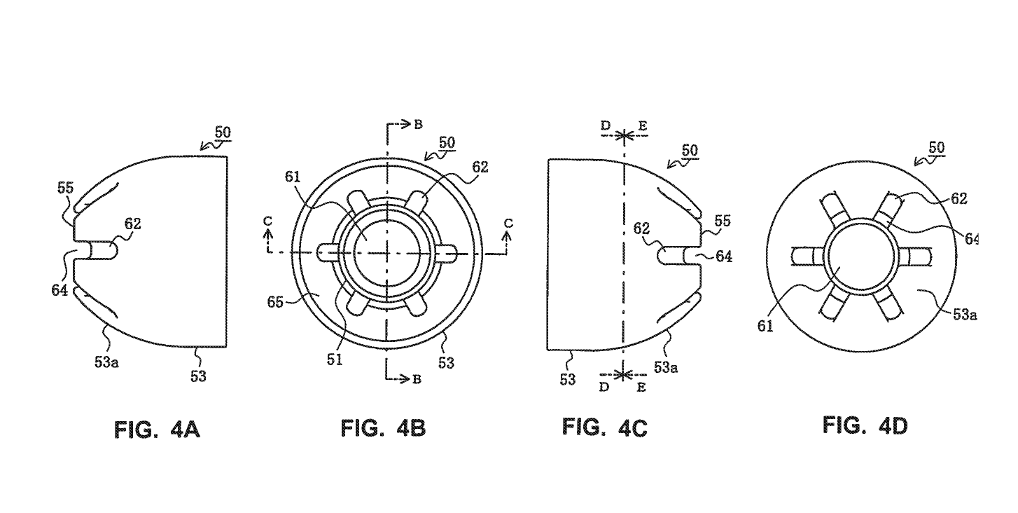

Referring to FIG. 4, which illustrates the configuration of the ear pad, the tip of the body portion 51 is connected to the tip of the cap portion 53 via a tip connecting portion 54, and the tip of each opening 62 is in communication with the tip of the pad sound guide hole 61 via a communication recess 64. Further, in the circular tip portion 55 of the ear pad 50, the tip connecting portions 54 and the communication recesses 64 are disposed alternately. Accordingly, the sounds, which impinged on the inside of the external auditory meatus passing through the casing sound guide hole 22 and the pad sound guide hole 61 from the driver unit 41, partially exit from the openings 62 to the outside via the communication recesses 64. Therefore, the sense of pressure, muffled quality, and the like of the sounds are reduced, which thereby makes the sounds clear.

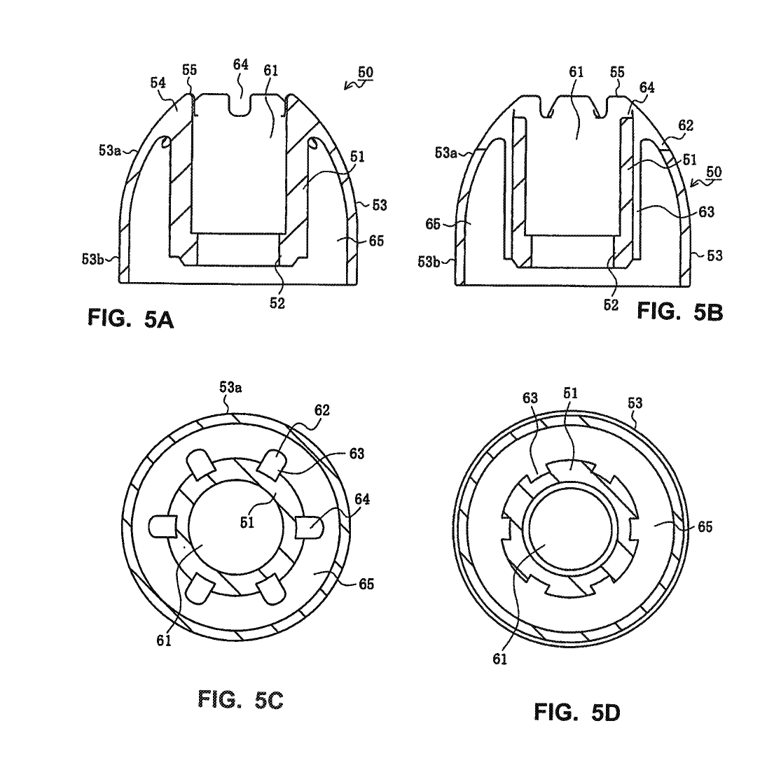

The tip connecting portion 54 is thicker than the cap portion 53 as shown in FIG. 5A and therefore has higher rigidity than the cap portion 53 and is undeformable. Moreover, the communication recesses 64 each disposed between the tip connecting portions 54 are formed so as to be recessed rearward from the tip edge of the tip portion 55, namely the tip edge of the tip connecting portion 54, viewed from the side surface. Accordingly, even in cases where the cap portion 53 is deformed when the ear pad 50 is inserted into the external auditory meatus, the communication recess 64 is not blocked, but the communication between the pad sound guide hole 61 and the openings 62 is maintained. As described above, even in cases where the cap portion 53 is deformed and pressed against not only the outer peripheral surface of the body portion 51, but the surface of the conical portion 16, the openings 62, the pad grooves 63, and the casing grooves 31 are in communication with each other. Therefore, a sound passage is stably secured from the pad sound guide hole 61 through the communication recesses 64, the openings 62, the pad grooves 63, and the casing grooves 31 to the outside, whereby the sense of pressure, muffled quality, and the like of the sounds are stably reduced and clear sounds are maintained.

Moreover, as shown in FIG. 5B, the tips of the openings 62 are preferably formed so as to be continued to the tips of the pad grooves 63, respectively. In this instance, even in cases where the cap portion 53 is significantly deformed, the communication between the openings 62 and the pad grooves 63 is stably maintained.

Further, in the front half portion 53a of the cap portion 53, the plurality of slit-shaped openings 62 radially extending when viewed from the front are formed as shown in FIG. 4D. Accordingly, the rigidity of the front half portion 53a is reduced and deformable due to the presence of the openings 62. Therefore, when the ear pad 50 is inserted into the external auditory meatus, not only the front half portion 53a, but also the entire cap portion 53 is flexibly and elastically deformed so as to fit to the inner surface shape of the external auditory meatus. Thus, the Present Application does not damage the external auditory meatus, but provides high safety. Further, the cap portion 53 comes in close contact with the inner surface of the external auditory meatus without applying a reaction force thereto, thereby providing a good wearing feeling, fit feeling, and the like.

In the shown example, the number of the openings 62, of the pad grooves 63, of the casing grooves 31, and of the communication recesses 64 is six. It, however, does not always need to be six, but may be either five or less or seven or greater.

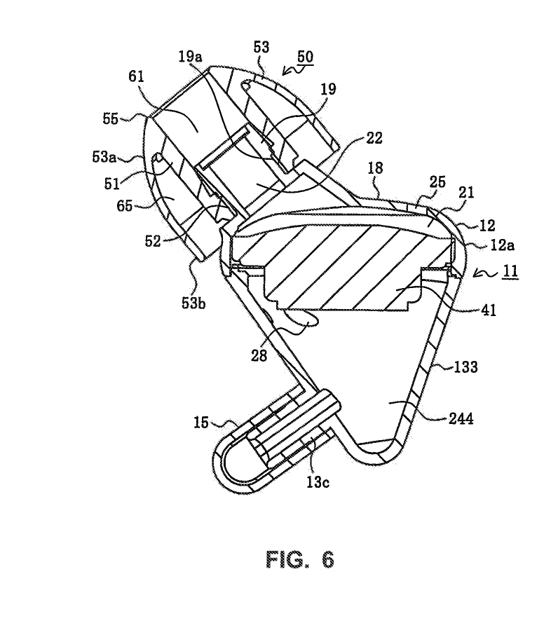

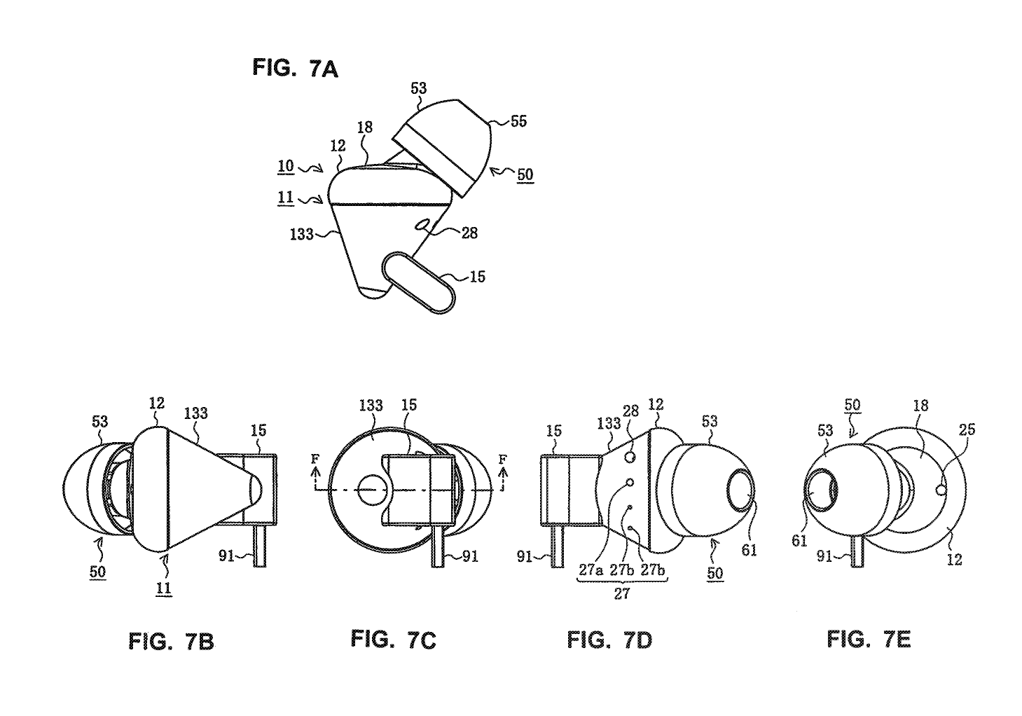

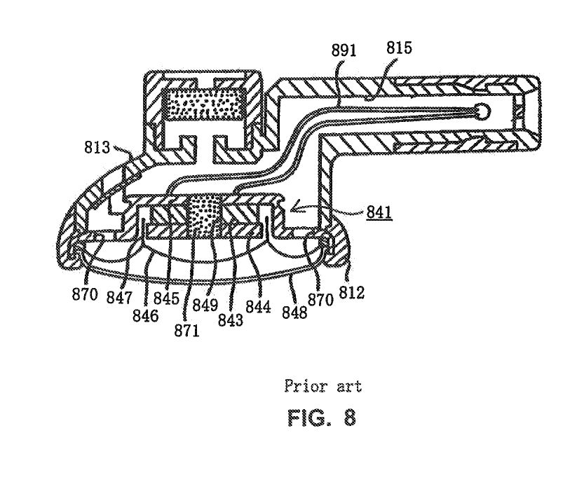

Referring to FIGS. 6-7, a casing 11 includes a front casing 12 located on the front side thereof and a conical rear casing 133 connected to the rear side of a base 12a of the front casing 12. Further, as shown in FIG. 6, the driver unit 41 is held inside the casing 11 with its front and rear (the upper side and the lower side in FIG. 6) interposed between the front casing 12 and the rear casing 133. Moreover, the rear casing 133 is a conical member closed at the rear end and having a pointed shape, by which a rear space 244, which is a space having a conical shape, is formed in the rear (the lower side in FIG. 6) of the driver unit 41 in the casing 11. The casing 11 is made of resin such as synthetic resin.

Further, a flat rectangular-parallelepiped cable holding portion 15, which encloses and holds a part of an electric wire cable 91 one end of which is connected to the driver unit 41, is mounted on a mounting projection 13c which is formed so as to project outward from the conical side surface of the rear casing 133. The cable holding portion 15 may be formed integrally with the rear casing 133. Further, the electric wire cable 91 extends from the cable holding portion 15.

In addition to the cylindrical base 12a, the front casing 12 includes a substantially flat circular plate portion 18 opposite to the front surface of the driver unit 41 and a cylindrical pad mounting portion 19 which projects from the circular plate portion 18. The front of the casing 11 is closed by the circular plate portion 18, thereby forming a front space 21, which is a cylindrical space short in the vertical dimension or a space having a shape like an inverted round dish, in the front (the upper side of FIG. 6) of the driver unit 41 within the casing 11. Moreover, in the pad mounting portion 19, there is formed a casing sound guide hole 22 as a sound guide hole which is a cylindrical opening whose rear end is in communication with the front space 21 and whose front end is open. Thereby, sounds generated by the driver unit 41 impinge on the external auditory meatus of a user through the front space 21 and the casing sound guide hole 22. Although the pad mounting portion 19 is formed in such a way that its central axis is inclined rightward with respect to the central axis of the front casing 12 and the central axis of the driver unit 41 in the shown example, the central axis of the pad mounting portion 19 may be inclined in any direction with respect to the central axis of the front casing 12 and the central axis of the driver unit 41. Further, the central axis of the pad mounting portion 19 does not always need to be inclined and may be parallel to the central axis of the front casing 12 and the central axis of the driver unit 41.

Moreover, a front air duct 25, as an air control hole which functions an air vent, is formed in the circular plate portion 18 of the front casing 12. The front air duct 25 is a hole having a circular cross section, which is formed so as to pass through the circular plate portion 18, and communicating the front space 21 with the outside to enable the air in the front space 21 to be vented to the outside. The front air duct 25 is formed so as to face forward to enable the air in the front space 21 to be vented forward.

Moreover, a rear air duct 28, as an air control hole which functions as an air vent, and a first control hole 27a and a second control hole 27b as tone control holes are formed in the conical side surface of the rear casing 133.

The rear air duct 28 is a hole having a circular cross section, which is formed so as to pass through the conical side surface of the rear casing 133, and communicating the rear space 244 with the outside to enable the air in the rear space 244 to be vented to the outside. The rear air duct 28 is formed so as to face diagonally backward to enable the air in the rear space 244 to be vented diagonally backward.

Moreover, the first control hole 27a and the second control hole 27b are holes each having a circular cross section formed so as to pass through the conical side surface of the rear casing 133 and to face diagonally backward. The first control hole 27a and the second control hole 27b communicate the rear space 244 with the outside and are adjacent to the rear air duct 28 and disposed in line on the same circumference in the rear casing 133.

Two second control holes 27b are disposed in FIGS. 6-7 in order to control the low-frequency sounds by the number of holes since the acoustic characteristics of the rear space 244 differ from those of the rear space 244 due to the conical shape of the rear casing 133 unlike FIGS. 1-5.

As illustrated in FIGS. 6-7, an ear pad 50 is directly mounted on the pad mounting portion 19. Specifically, an engaging convex portion 52 engages with a grooved engaging concave portion 19a which is formed in the pad mounting portion 19 to prevent the ear pad 50 from being detached from the pad mounting portion 19.

Further, the ear pad 50 in FIGS. 6-7 does not have openings 62 and pad grooves 63. In other words, the openings 62 and the pad grooves 63 are omitted in FIGS. 6-7.

As described above, in FIGS. 6-7, the earphone 10 has the ear pad 50 at least a part of which is insertable into the external auditory meatus, the casing 11 to which the ear pad 50 is attached, and the driver unit 41 which is disposed within the casing 11 to generate sounds. The casing 11 includes the front space 21 formed in front of the driver unit 41, the casing sound guide hole 22 which is in communication with the front end of the front space 21 to cause the sounds to impinge on the external auditory meatus, and the rear space 244 which is formed in the rear of the driver unit 41. The front space 21 includes the front air duct 25, which is in communication with the outside. The rear space 244 includes the rear air duct 28 in communication with the outside and the tone control hole 27 in communication with the outside and having a smaller diameter than the rear air duct 28.

Thereby, it is possible to appropriately control the air balance between the front space 21 and the rear space 244 and to reduce the load on the diaphragm of the driver unit 41. Moreover, it is possible to correct sound distortion and echo, thereby improving the sound quality. Further, both of high sounds and low sounds are smoothed, thus enabling the sounds to create a feeling of openness.

In other words, these tone control holes 27 determines the range to be controlled by the diameters of the holes, controls the characteristics by the number of the holes, and controls the air balance which leads to the feeling of openness in the sounds.

Further, the rear air duct 28 and the tone control holes 27 formed in the side surface portion 13b of the rear casing 133 are disposed on the same circumference, in other words, on a virtual plane which is perpendicular to the vibrating direction of the diaphragm of the driver unit, and therefore the control holes are disposed in the positions the same in distance from the diaphragm, by which sounds are controllable more effectively.

Moreover, in FIGS. 1-5, the front space 21 is a truncated cone-like space, the front air duct 25 is formed in the surface opposed to the driver unit 41 in the front space 21 so as to face forward, the rear space 24 is a cylindrical space having a flat surface opposed to the driver unit 41, and the rear air duct 28 and the tone control holes 27 are formed in a cylindrical side surface in the rear space 24 so as to face laterally. Thereby, it is possible to reproduce sharp low sounds and clear mid and high sounds while favorably letting out the sounds.

Further, the diameter of the front air duct 25 is equal to the diameter of the rear air duct 28. Thereby, it is possible to control the air balance between the front space 21 and the rear space 24 favorably.

Still further, the tone control holes 27 include the first control hole 27a which controls the sound quality of high sounds and the second control hole 27b which is smaller in diameter than the first control hole 27a and controls the sound quality of low sounds. Thereby, it is possible to control the sound quality of a desired frequency band appropriately.

In FIGS. 6-7, the casing 11 is made of resin and includes the cylindrical front space 21, which is formed in the front of the driver unit 41, the casing sound guide hole 22, which is in communication with the front end of the front space 21 to cause sounds to impinge on the external auditory meatus, and the conical closed rear space 24, which is formed in the rear of the driver unit 41. The rear space 244 includes the tone control holes 27 open and facing diagonally backward.

As described hereinabove, the earphone houses the driver unit 41, and the front space 21 and the rear space 244 formed in front and the rear of the driver unit 41 have the tone control holes 27. Therefore, the tone control holes 27 are able to control the sound quality of a desired frequency band appropriately to achieve satisfactory acoustic characteristics.

Further, the surface opposed to the driver unit 41 in the front space 21 is a flat surface, and the front space 21 includes the front air duct 25 which is open and faces forward. The surface opposed to the driver unit 41 in the rear space 244 is a conical surface, and the rear space 244 includes the rear air duct 28 which is open and faces diagonally backward. Thereby, it is possible to correct sound distortion and echo and to reduce a load on the diaphragm of the driver unit 41.

The Present Application is applicable to an earphone having an external auditory meatus insertion member at least a part of which is inserted into an external auditory meatus.

While a preferred embodiment of the Present Application is shown and described, it is envisioned that those skilled in the art may devise various modifications without departing from the spirit and scope of the foregoing Description and the appended Claims.

What is claimed is:

1. An earphone (10) comprising:
an external auditory meatus insertion member (50) at least a part of which is insertable into an external auditory meatus;
a casing (11) to which the external auditory meatus insertion member (50) is attached; and
a driver unit (41) which is disposed within the casing (11) to generate sounds;
wherein the casing (11) includes a front space (21) formed in front of the driver unit (41), a sound guide hole (22) which is in communication with the front end of the front space (21) to cause sounds to impinge on the external auditory meatus, and a rear space (24) which is formed in the rear of the driver unit (41).

2. The earphone (10) of claim 1, wherein the front space (21) includes a front air control hole (25), which is in communication with the outside.

3. The earphone (10) of claim 2, wherein the rear space (24) includes a rear air control hole (28) which is in communication with the outside and a tone control hole (27), which is in communication with the outside, having a smaller diameter than the rear air control hole (28).

4. The earphone (10) of claim 3, wherein the rear air control hole (28) and the tone control hole (27) are disposed in a surface perpendicular to the vibrating direction of a diaphragm of the driver unit (41).

5. The earphone (10) of claim 4, wherein the front space (21) is a truncated cone-like space.

6. The earphone (10) of claim 5, wherein the front air control hole (25) is formed in a surface opposed to the driver unit (41) in the front space (21) so as to face forward.

7. The earphone (10) of claim 6, wherein the rear space (24) is a cylindrical space having a flat surface opposed to the driver unit (41).

8. The earphone (10) of claim 7, wherein the rear air control hole (28) and the tone control hole (27) are formed in a cylindrical side surface in the rear space (24) so as to face laterally.

9. The earphone (10) according to claim 8, wherein the diameter of the front air control hole (25) is equal to the diameter of the rear air control hole (28).

10. The earphone (10) according to claim 9, wherein the tone control hole (27) includes a first control hole (27a) which controls the sound quality of a predetermined range and a second control hole (27b) which is smaller in diameter than the first control hole (27a) and controls the sound quality of lower sounds than the predetermined range.

11. The earphone (10) according to claim 1, wherein the diameter of the front air control hole (25) is equal to the diameter of the rear air control hole (28).

12. The earphone (10) according to claim 11, wherein the tone control hole (27) includes a first control hole (27a) which controls the sound quality of a predetermined range and a second control hole (27b) which is smaller in diameter than the first control hole (27a) and controls the sound quality of lower sounds than the predetermined range.

13. The earphone (10) according to claim 1, wherein the tone control hole (27) includes a first control hole (27a) which controls the sound quality of a predetermined range and a second control hole (27b) which is smaller in diameter than the first control hole (27a) and controls the sound quality of lower sounds than the predetermined range.

14. The earphone (10) according to claim 2, wherein the diameter of the front air control hole (25) is equal to the diameter of the rear air control hole (28).

15. The earphone (10) according to claim 14, wherein the tone control hole (27) includes a first control hole (27a) which controls the sound quality of a predetermined range and a second control hole (27b) which is smaller in diameter than the first control hole (27a) and controls the sound quality of lower sounds than the predetermined range.

16. The earphone (10) according to claim 2, wherein the tone control hole (27) includes a first control hole (27a) which controls the sound quality of a predetermined range and a second control hole (27b) which is smaller in diameter than the first control hole (27a) and controls the sound quality of lower sounds than the predetermined range.

17. The earphone (10) according to claim 3, wherein the tone control hole (27) includes a first control hole (27a) which controls the sound quality of a predetermined range and a second control hole (27b) which is smaller in diameter than the first control hole (27a) and controls the sound quality of lower sounds than the predetermined range.
